(19) United States
(12) Patent Application Publication
(10) Pub. No.: US 2007/0280256 A1
(43) Pub. Date: Dec. 6, 2007

(54) SYSTEMS AND METHODS FOR PROVIDING A HEARTBEAT IN A COMMUNICATIONS NETWORK

(76) Inventor: Jan Forslow, San Mateo, CA (US)

Correspondence Address: KALI LAW GROUP, P. C, P.O. BOX 60187, SUNNYVALE, CA, 94088-0187, US

(21) Appl. No.: 11/756,713

(22) Filed: Jun. 1, 2007

Related U.S. Application Data
(60) Provisional application No. 60/810,467, filed on Jun. 1, 2006.

(51) Int. Cl. H04L 12/56

(52) U.S. Cl. 370/395.2

(57) ABSTRACT

Methods for providing a heartbeat during a communication session utilizing repetitive control messages in a communications network, the communication session configured for delivering a media stream, are presented including: transmitting the repetitive control message between participants in the communication session at a selected rate corresponding with the heartbeat, wherein the participants includes a talking participant and a listening participant, and wherein the repetitive control messages provide updated status for the participants. In some embodiments, method further include: setting timers corresponding with the repetitive control messages; and if any of the timers expires before an acknowledgement of any of the repetitive control messages is received from the participants, triggering one or more actions to update the participants of a change in status for the communication session. In some embodiments, the selected rate is in the range of approximately 0 to 5 seconds.

### PRIORITY CLAIM TO PROVISIONAL APPLICATION

A claim for priority is hereby made under the provisions of 35 U.S.C. § 119 for the present application based upon U.S. Provisional Application No. 60/810,467, filed on Jun. 1, 2006, which is incorporated herein by reference.

### BACKGROUND

Open Mobile Alliance™(OMA) has defined a Push-to-talk over Cellular (PoC) systems which utilize floor control procedures called Talk Burst Control Protocol (TBCP) with minimal or no acknowledgements. This minimalist approach is somewhat compensated by enabling timers to run on both sides of all connections of a PoC session to handle abnormalities. However, recent rollout of OMA PoC compliant systems in communications networks have shown that TBCP may provide an inadequate user experience in the event of loss of connectivity, e.g. in case of temporary out of coverage conditions due to low coverage or heavy congestion and in case of abrupt disconnects due to incoming GSM circuit-switched calls or driving/walking into no coverage area for a prolonged period of time. More often than not, connected parties are left unaware that their session has been interrupted and often resort to taking the floor multiple times and asking, for example, “Are you there?” in order to determine the status of the connection.

Push-to-talk Over Cellular (PoC) is standardized by Open Mobile Alliance™(OMA). This standard is discussed in greater detail in the following technical specifications which are hereby incorporated by reference in their entirety:

“Push to talk over Cellular Requirements”, Candidate Version 1.0-29 Mar. 2005, Open Mobile Alliance™, OMA-RD-PoC-V1_{—}0-20050329-C;

“Push to talk over Cellular Architecture”, Candidate Version 1.0-19 May 2006, Open Mobile Alliance™, OMA-AD_PoC-V1_{—}0-20060519-C;

“PoC XDM Specification”, Candidate Version 1.0-19 May 2006, Open Mobile Alliance™, OMA-TS-PoC-XDM-V1_{—}0-20060519-C;

“PoC Control Plane”, Candidate Version 1.0-19 May 2006, Open Mobile Alliance™, OMA-TS-PoC-ControlPlane-V1_{—}0-20060519-C; and

“PoC User Plane”, Candidate Version 1.0-19 May 2006, Open Mobile Alliance™, OMA-TS-PoC-UserPlane-V1_{—}0-20060519-C.

The OMA PoC Version 1 standard utilizes a Talk Burst Control Protocol (TBCP) for allocating the floor to a PoC session participant. TBCP is detailed in the OMA PoC User Plane specification. A high-level overview also exists in the OMA PoC Architecture document. A PoC server TBCP state machine manages the allocation of floor to PoC session participants.

FIG. 1 is an illustrative prior art representation of a PoC System Architecture in accordance with OMA PoC/PAG version 1 specifications. An OMA PoC system architecture 100 includes User Equipment (UE) 102 and a set of network components. As illustrated, UE 102 contains the necessary pieces to interface the user acting as participant in a PoC session under the OMA version 1 specifications. UE 102 can either be a mobile terminal, a PC or any other device connected to the access network. Device Management (DM) client 104 inside UE 102 is used to bootstrap UE 102 with necessary configuration data from a DM server 116. An XML Document Management Client (XDMC) 110 is used to download and update by request any relevant contact lists stored in Shared XML Document Management Server (XDMS) 122. An Aggregation Proxy 124 may be configured to perform the authentication of any such requests. Similarly, the XDMC 110 is also configured to communicate via Aggregation Proxy 124 with PoC-specific XDMS (PoC XDMS) 126 for the purpose of managing group policies and authorization lists. UE 102 further includes Presence Source 106 and Presence Watcher 108. Presence Source 106 may be configured to publish a UE's availability status to other users. Presence Watcher 108 may be configured to retrieve availability status of others (e.g. other UEs and contacts). Both UE presence entities communicate with Presence Server 120 via a SIP/IP Core 118. In an OMA PoC system built on top of a GPRS radio network, a SIP/IP Core is often a IP Multimedia Subsystem (IMS) as standardized by the 3rd Generation Partnership Project (3GPP).

A PoC client's main responsibilities are: session management, SIP registration, TBCP request-response management, media transmission, and media reception. Under existing standards, session management, SIP registration may be accomplished over POC-1 and POC-2 interfaces 132 and 136 respectively. Furthermore, TBCP request-response management, media transmission, and media may be accomplished over POC-3 interface 134. PoC server 128 is responsible for application level network functionality including PoC session establishment, termination, handling of TBCP messages and media switching between the participating clients.

POC-3 interface 134 is where TBCP is applied as a floor control protocol and where media is sent using Real-time Transfer Protocol (RTP). TBCP state machines are instantiated in PoC clients and PoC servers after a successful Session Initiation Protocol (SIP) session establishment has occurred on POC-1 132 and POC-2 136. In an OMA PoC system, when a PoC client sends a TBCP_REQUEST message to a PoC server to ask for permission to talk, the PoC server determines whether or not to grant permission based on floor availability. Permission is communicated back to the PoC client using appropriate messages (i.e. TBCP_GRANTED message or TBCP_DENY message). If the PoC server sends TBCP_GRANTED message, this means that the PoC server grants permission to a requesting PoC client to speak whereupon media will be forwarded to other participants when received. If the PoC server sends a TBCP_DENY message to a requesting PoC client, this means that the request is rejected whereupon media will be dropped by the PoC server if received. Once floor is granted to one participant (the talker), the PoC server substantially simultaneously sends TBCP_TAKEN messages to all other participant(s) (i.e. listeners). If a talker speaks for too long as defined by a T2 (Stop talking) timer, then the PoC server will send a TBCP_REVOKE message to the talker PoC client, which in turn responds with a TBCP_RELEASE message. If the PoC server does not receive a TBCP_RELEASE message before a T3 (Stop talking grace) timer, the PoC server will penalize the talker PoC client by not acknowledging further media or TBCP_REQUEST messages for a duration of a T8 (Talk Burst REVOKE message) timer. The PoC server will instead make the floor available for other participant(s) by sending a TBCP_IDLE messages accordingly.

FIG. 2 is an illustrative prior art dataflow 200 for a Talk Burst in a 1-to-1 PoC session applying lazy-lock mode and experiencing loss of connectivity on talker side after floor grant. In this prior art representation Lazy-lock mode is applied and allows for a shorter volley time. Lazy-lock modes are discussed in U.S. patent application Ser. No. 11/696,866 entitled, SYSTEMS AND METHODS FOR IMPLEMENTING LAZY-LOCK CONTROL PROCEDURE IN REAL-TIME COMMUNICATIONS SERVICES, which is incorporated herein by reference. Lazy-lock modes allow a talking client to send media directly after requesting the floor by sending a TBCP_REQUEST message. The dataflow begins when PoC server 270 sends TBCP_IDLE messages 202 and 204 to all participants (i.e. PoC client-A 284 and PoC client-B 264) to signal that the floor is available. User-A 282 presses a PTT button 206 to indicate a desire to take the floor and begins speaking 210. PoC client-A 284, utilizing a Lazy-lock mode, sends a TBCP_REQUEST message 208 to PoC server 270 and forwards media 210 to PoC server 270 before receiving a grant message. PoC client-A starts T11 (Cumulative Talk Burst Request) timer 211 that governs how many times a TBCP_REQUEST message shall be resent before giving up. PoC server 270 receives TBCP_REQUEST message 208 and verifies that the floor is still available for streaming media from PoC client-A 284 to PoC client-B 264. If the floor is available, PoC server 270 then responds with a TBCP_GRANTED message 212 to PoC client-A. At substantially the same time, PoC server 270 sends TBCP_TAKEN message 214 to PoC client-B 264 followed by media 218. In some embodiments, PoC server may process media from a sending PoC client before forwarding to receiving PoC client. PoC server starts T1 (End of RTP media) timer 219 that governs how long PoC server 270 will maintain the floor allocation without receiving media from PoC client-A 284. T1 (End of RTP media—Talker) timer 219 is re-started every time new media is received from PoC client-A 284. When PoC client-A 284 received TBCP_GRANTED message 212, PoC client-A 284 stops T11 (Cum. TBCP_REQUEST) timer 211.

At some point during transmission, media may be dropped for any number of reasons. As illustrated, media 220 is dropped before reaching PoC server 270. When PoC server 270 fails to receive media, T1 (End of RTP media—Talker) timer 219 may expire (a typical value is 6 sec) before connection is restored. When T1 (End of RTP media—Talker) timer 219 expires, PoC server 270 sends a TBCP_REVOKE message 222 towards PoC client-A 284 and starts T3 (Stop talking grace) timer 223. T3 (Stop talking grace) timer 223 would normally stop when a TBCP_RELEASE message is received from PoC client-A 284. However, in this illustration, PoC client-A 284 is not reachable. Thus, TBCP_REVOKE message 222 is dropped by the network and T3 (Stop talking grace) timer 223 expires (a typical value being 3 sec). When T3 (Stop talking grace) timer 223 expires, PoC server 270 takes the PoC session to an IDLE state by sending TBCP_IDLE messages 224 and 226 to all participants. PoC server 270 starts T4 (Inactivity) timer 225 after sending TBCP_IDLE messages 224 and 226. T4 (Inactivity) timer 225 governs the interval that determines when a PoC session shall be dismantled if not in use. That is, when no Talk Burst messages are requested or sent.

As the TBCP_IDLE message 224 is also dropped by the network before reaching PoC client-A 284, user-A 282 may be unaware that he doesn't have the floor anymore and may continues to send media 230. User-A 282 may, at some point, realize that he is not being heard and releases the PTT button. When the PTT button is released, a TBCP_RELEASE message 232 is sent by PoC client-A 284 to PoC server 270. However, that message is also dropped. Subsequent attempts to regain control of the floor by pressing PTT button 234 and sending TBCP_REQUEST message 236 will fail if no connection is established. Furthermore, any media 238 sent will also be dropped. As above, when PoC client-A 284 makes a request for the floor, a T11 (Cum. TBCP_REQUEST) timer 239 is started. Here, no TBCP_GRANTED message is received from the communications network triggering so T11 (Cum. TBCP_REQUEST) timer 239 expires. When T11 (Cum. TBCP_REQUEST) timer 239 expires, PoC client-A 284 sends ready indicator 240 (Network Busy) to user-A 282. Eventually user-A will likely terminate the local instance of the PoC session in PoC client-A due to fatigue (not shown in FIG. 2). In addition, when T4 (Inactivity) timer 225 expires, PoC server 270 will terminate the PoC session by sending SIP_BYE messages 242 and 244 whereupon, PoC client-B 264 returns acknowledgement (200 OK) message 248 to PoC server 270. PoC client-B 264 may also send an indicator 246 to user-B 262 to indicate that no active user is present. As can be seen from the above example, typical configurations may suffer from extended periods during the Talk Burst where user-A is not aware of that media is not reaching PoC client-B. Furthermore, in conventional solutions, termination of the PoC session is not synchronized between a PoC client that lost connectivity and the PoC server.

FIG. 3 is an illustrative prior art dataflow for a Talk Burst in a 1-to-1 PoC session applying lazy-lock mode and experiencing loss of connectivity on listener side after granting floor. In the above prior art example for FIG. 2, the talker looses connectivity with the communications network. In FIG. 3, the listener looses connectivity with the communications network. The dataflow begins when PoC server 370 sends TBCP_IDLE messages 302 and 304 to all participants (i.e. PoC client-A 384 and PoC client-B 364) to signal that the floor is available. User-A 382 presses a PTT button 306 to indicate a desire to take the floor and begins speaking 310. PoC client-A 384, utilizing a Lazy-lock mode, sends a TBCP_REQUEST message 308 to PoC server 370 and forwards media 310 to PoC server 370 before receiving a grant message. PoC server 370 receives TBCP_REQUEST message 308 and verifies that the floor is still available for streaming media from PoC client-A 384 to PoC client-B 364. If the floor is available, PoC server 370 then responds with a TBCP_GRANTED message 312 to PoC client-A. At substantially the same time, PoC server 370 sends TBCP_TAKEN message 314 to PoC client-B 364 followed by media 318.

When PoC client B 364 receives media 318, a T13 (End of RTP media) timer 319 is started as defined by OMA PoC standards. In this example, PoC client-B 364 loses connectivity with the communications network for any number of reasons. When T13 (End of RTP media) timer 319 expires, PoC client-B will move to IDLE state. User-A 382, however, continues to communicate with PoC server 370 through PoC client-A 384 thinking that he is communicating with user-B 362 in dataflow steps 320-326 and 330-340. At some point in time, user-A 382 ends the call 324. As above, when a call is ended or when T4 (Inactivity) timer 327 expires, PoC server 370 will terminate the PoC session by sending SIP BYE messages 346 and 350, whereupon, PoC server 370 returns acknowledgement (200 OK) message 348 to PoC client-A 384. As above example, typical configurations may suffer from extended periods during the Talk Burst where user-A is not aware of that media is not reaching PoC client-B. Furthermore, in conventional solutions, termination of the PoC session is not synchronized between a PoC client that lost connectivity and the PoC server.

It may, therefore, be advantageous to employ methods for determining a state of floor control to avoid extended periods where users are not aware of changes in connectivity between users. As such, systems and methods for providing a heartbeat in a communications network are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, methods for providing a heartbeat during a communication session utilizing repetitive control messages in a communications network, the communication session configured for delivering a media stream, are presented including: transmitting the repetitive control message between participants in the communication session at a selected rate corresponding with the heartbeat, wherein the participants includes a talking participant and a listening participant, and wherein the repetitive control messages provide updated status for the participants. In some embodiments, method further include: setting timers corresponding with the repetitive control messages; and if any of the timers expires before an acknowledgement of any of the repetitive control messages is received from the participants, triggering one or more actions to update the participants of a change in status for the communication session. In some embodiments, the selected rate is in the range of approximately 0 to 5 seconds. In some embodiments, the communications network is selected from the group consisting of: a server based network, a peer-to-peer network, a PoC network, and a VolP enabled network. In some embodiments, the heartbeat operates as in explicit floor control environment for the communication session selected from the group consisting of: a Push-To-Talk (PTT) session, a PTT-over-Cellular (PoC) session, a simplex media session, a Voice-over-IP (VoIP) conference call session. In some embodiments, the repetitive control messages include: a repetitive TBCP_REQUEST message, a repetitive TBCP GRANTED message, a repetitive TBCP_TAKEN message, a repetitive TBCP_ACK message, and a repetitive TBCP_IDLE message. In some embodiments, the timers include: OMA PoC version 1 User Plane timers, a T31 (Inactivity—Listener) timer on a listening PoC client, a T32 (Start buffering) timer on a PoC server, a T33 (End of RTP media—Listener) timer on the PoC server, and a T34 (Inactivity—Listener) timer on the PoC server. In some embodiments, the actions include: a) if the T32 (Start buffering) timer expires due to not receiving the acknowledgement buffering the media stream on a server on behalf of the listening participant, and releasing the media stream when a next acknowledgement is successfully received from the talking participant; b) bringing the communication session to an IDLE state by the server in a 1 to 1 communication session when either a T1 (End of RTP media—Talker) timer expires due to lack of media stream from the talking participant or when the T33 (End RTP media—Listener) timer expires due to lack of a TBCP_ACK message from the listening participant based on the repetitive TBCP_TAKEN messages, and setting a number associated timers in each of the participants, wherein the associated timers is selected from the group consisting of: a T13 (End of RTP media) timer in the talking participant, and a T11 (Cumulative TBCP_REQUEST) timer in the listening participant, wherein the T11 (Cumulative TBCP_REQUEST) timer is set to a value equivalent to the T1 (End of RTP media—Talker) timer and the T13 (End of RTP media) timer; and c) declaring the listening participant as not reachable by the server when either a T4 (Inactivity) timer expires due to lack of the media stream or the T34 (Inactivity—Listener) timer expires due to lack of the TBCP_ACK message from the listening participant based on the repetitive TBCP_TAKEN message, setting the T31 (Inactivity—Listener) to a value equivalent to the T4 (Inactivity) timer and the T34 (Inactivity—Listener) timer, and removing the listening participant from the communication session.

In other embodiments, methods for providing a floor control-based heartbeat during a Push-to-Talk-over-Cellular (PoC) session utilizing a number of repetitive control messages in a PoC network, the PoC session configured for delivering a media stream, are presented including: sending the repetitive control messages between a PoC server and a number of PoC clients in the PoC session during a single talk burst at a rate corresponding with the heartbeat, wherein the PoC clients includes a talking PoC client and a listening PoC client, and wherein the repetitive control messages provide at least updated status for the PoC clients. In some embodiments, setting the timers corresponding with the repetitive control messages; if any of the timers expires before an acknowledgement of any of the repetitive control messages is received from the PoC clients, triggering one or more of a number of actions to update the PoC clients of a change in status for the PoC session. In some embodiments, the repetitive control messages include: a repetitive TBCP_REQUEST message, a repetitive TBCP GRANTED message, a repetitive TBCP_TAKEN message, a repetitive TBCP_ACK message, and a repetitive TBCP_IDLE message. In some embodiments, the rate is in the range of approximately 0 to 5 seconds. In some embodiments, the rate is approximately 2 seconds.

In other embodiments, methods for providing a heartbeat in an Open Mobile Alliance (OMA) compliant Push-to-Talk over Cellular (PoC) system between a PoC server and at least two PoC clients during a single talk burst in an ongoing PoC session wherein the at least two PoC clients includes a talking PoC client and a listening PoC client, are presented including: applying a repetitive TBCP_REQUEST message by the talking PoC client to the PoC server; acknowledging the repetitive TBCP_REQUEST message with a repetitive TBCP_GRANTED message by the PoC server to the talking PoC client; applying a repetitive TBCP_TAKEN message by the PoC server to the listening PoC client; acknowledging the repetitive TBCP_TAKEN message with a repetitive TBCP_ACK message by the listening PoC client to the PoC server; if either the acknowledging fails, triggering a of three levels of actions upon expiry of one of a number of timers associated with the repetitive messages in order to inform the at least two PoC clients of an out of coverage condition wherein the actions include, a) buffering the media stream on the PoC server on behalf of the listening PoC client when a T32 (Start buffering) timer expires, and releasing the media stream when a next acknowledging is successfully received from the talking PoC client; b) bringing the PoC session to an IDLE state by the PoC server in a 1-to-1 session when either a T1 (End of RTP media—Talker) timer expires due to lack of media stream from the talking PoC client or when a T33 (End RTP media—Listener) timer expires due to lack of the TBCP_ACK messages from the listening PoC client based on the repetitive TBCP_TAKEN messages, setting the associated timers in each of the PoC clients, wherein the associated timers is selected from the group consisting of: a T13 (End of RTP media) timer in the talking PoC client, and a T11 (Cumulative TBCP_REQUEST) timer in the listening PoC client, wherein the T11 (Cumulative TBCP_REQUEST) timer is set to a value equivalent to the T1 (End of RTP media—Talker) timer and the T13 (End of RTP media) timer; and c) declaring the listening PoC client as not reachable by the PoC server when either a T4 (Inactivity) timer expires due to lack of the media stream or a T34 (Inactivity—Listener) timer expires due to lack of the TBCP_ACK messages from the listening PoC client based on the repetitive TBCP_TAKEN messages, setting a T31 (Inactivity—Listener) to a value equivalent to the T4 (Inactivity) timer and the T34 (Inactivity—Listener) timer, and removing the listening PoC client from the PoC session.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative prior art representation of a PoC System Architecture in accordance with OMA PoC/PAG version 1 specifications;

FIG. 2 is an illustrative prior art dataflow for a Talk Burst in a 1-to-1 PoC session applying lazy-lock mode and experiencing loss of connectivity on talker side after floor grant;

FIG. 3 is an illustrative prior art dataflow for a Talk Burst in a 1-to-1 PoC session applying lazy-lock mode and experiencing loss of connectivity on listener side after granting floor;

FIG. 4 is an illustrative dataflow for a Talk Burst in a 1-to-1 PoC session applying lazy-lock mode and experiencing no loss of connectivity on either side in accordance with embodiments of the present invention;

FIGS. 5A-B illustrate a dataflow for a Talk Burst in a 1-to-1 PoC session applying lazy-lock mode and experiencing loss of connectivity on listener side after TBCP_TAKEN message is received in accordance with embodiments of the present invention;

FIGS. 6A-B illustrate a dataflow for a Talk Burst in a 1-to-1 PoC session applying lazy-lock mode and experiencing loss of connectivity on listener side before TBCP_TAKEN message is received in accordance with embodiments of the present invention;

FIG. 7 is an illustrative dataflow for a Talk Burst in a 1-to-1 PoC session applying lazy-lock mode and experiencing loss of connectivity in IDLE state until PoC server T4 (Inactivity) timer expiries in accordance with embodiments of the present invention; and

FIG. 8 is an illustrative dataflow for a Talk Burst in a 1-to-1 PoC session applying lazy-lock mode and experiencing loss of connectivity on a talker side after TBCP_GRANTED message is received in accordance with embodiments of the present invention.

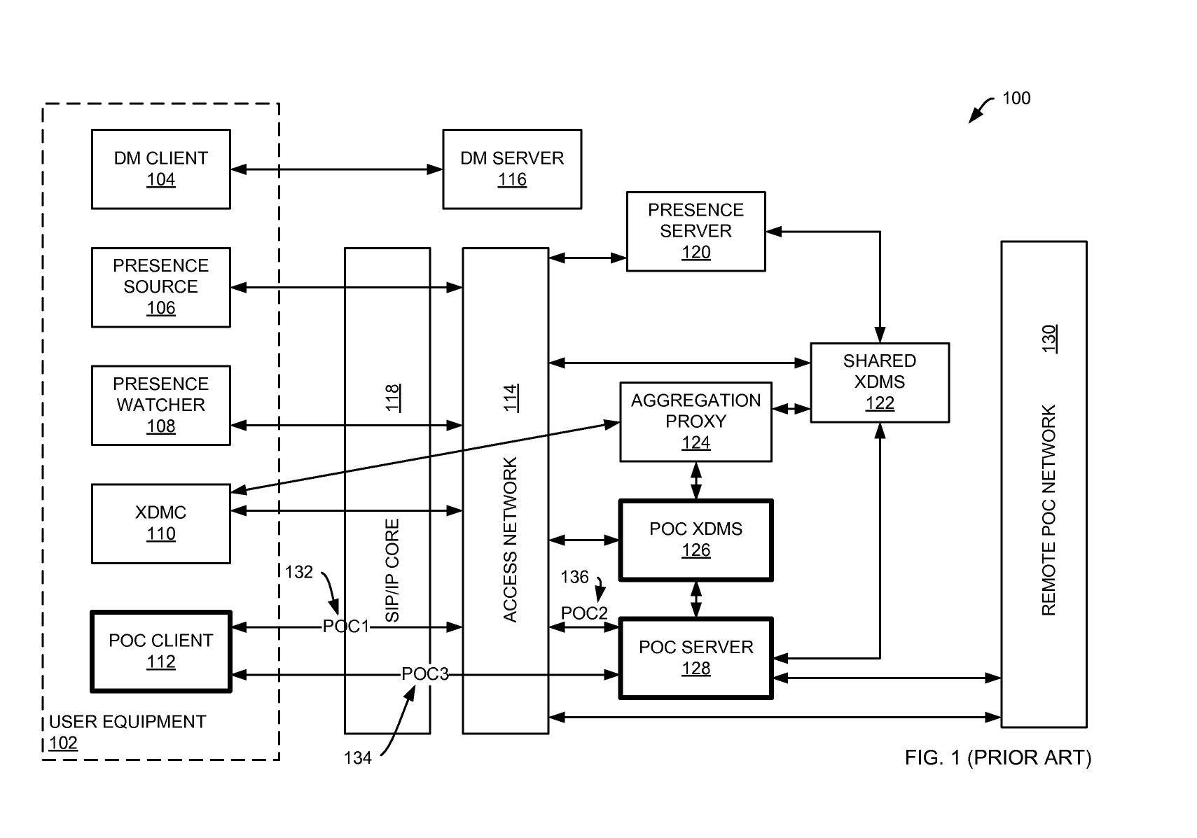

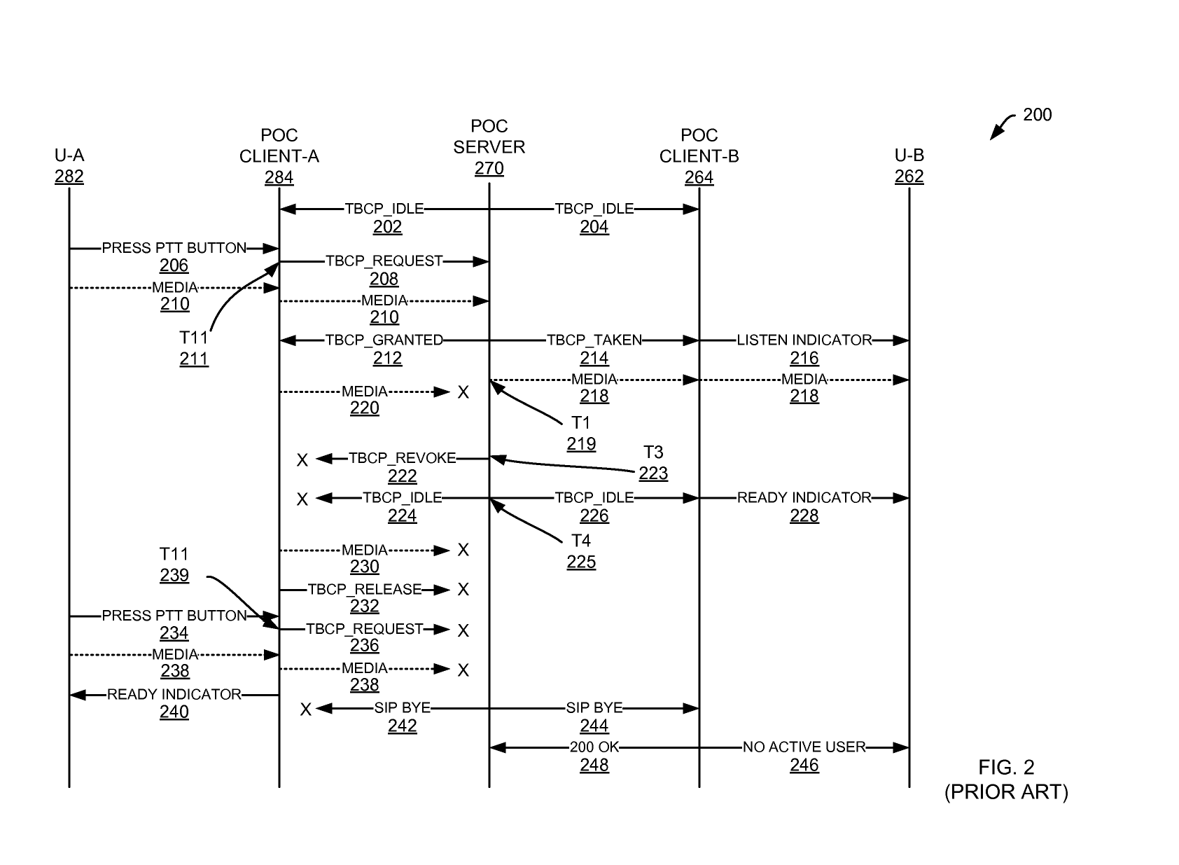

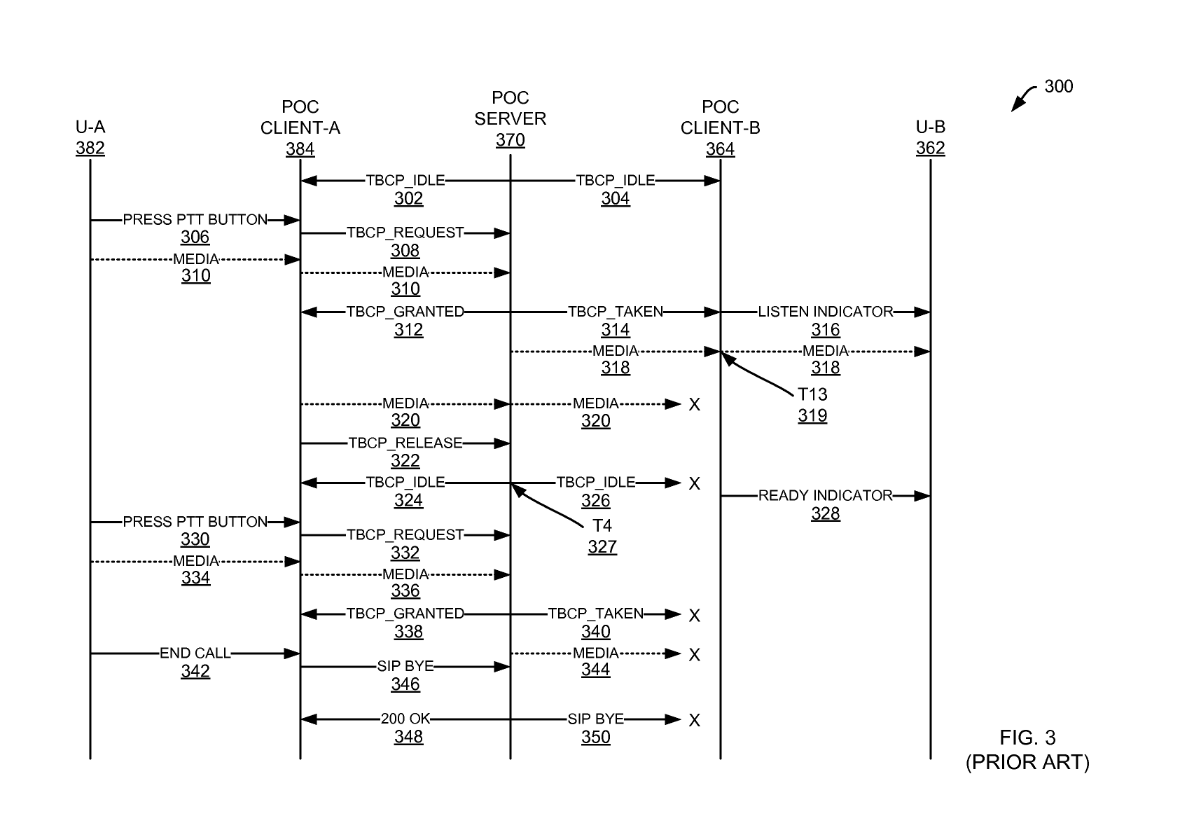

GLOSSARY

| | |
|---|---|
| DM - Device | OMA defined protocol for bootstrapping handsets with |
| Management | configuration data from an Over-the-Air (OTA) |
| | provisioning server. |
| GSM - Global | The second generation digital technology originally |
| System for | developed for Europe but which now has in excess of |
| Mobile | 71% of the world market. Initially developed for |
| communication | operation in the 900 MHz band and subsequently |
| | modified for the 850, 1800 and 1900 MHz bands. |
| GPRS - | Packet switched service on GSM networks that |
| Generic Packet | provides an Internet Protocol bearer for |
| Radio Service | applications such as PoC. |
| IMS Core - | The SIP/IP Core that controls call sessions over |
| IP Multimedia | IP networks in cellular networks. |
| Subsystem | |
| OMA - Open | Standardization organization focused on mobile |
| Mobile Alliance | application specifications such as PoC. |
| PoC - | Push to Talk standard from OMA using the IP |
| Push-to-Talk- | bearer of cellular packet switched networks |
| over-Cellular | such as GPRS. |
| PTT - | Similar to conventional walkie-talkie |
| Push-To-Talk | communication - users send a voice message to one |
| | or more recipients from a mobile phone by pushing |
| | a key. |
| RTP - Real- | An IETF protocol for real-time transmission of |
| time Transfer | audio and video. Current IETF RFC is 3550. |
| Protocol | http;//www.ietf.org/rfc/rfc3550.txt |
| SDP - | SDP is used for describing and negotiating media |
| Session | characteristics as part of setting up multimedia |
| Description | sessions using SIP. The basic IETF RFC is 2327. |
| Protocol | http://www.ietf.org/rfc/rfc2327.txt?number=2327 |
| Shared | An XCAP server that manages XML documents (e.g. |
| XDMS - Shared | Contact Lists) that are needed for the PoC service |
| XML Document | and which may be shared with other service |
| Management | enablers (e.g. Presence). |
| Server | |
| SIP - | A signaling protocol for Internet conferencing, |
| Session | telephony, presence, events notification, and |
| Initiation | instant messaging. The current IETF RFC is 3261. |
| Protocol | http://www.ietf.org/rfc/rfc3261.txt?number=3261 |
| TBCP - Talk | A floor control protocol defined by OMA for PoC |
| Burst Control | using RTP control messages. |
| Protocol | |
| UE - User | A terminal (e.g. handset or PC) with the PoC |
| Equipment | client application installed. |
| XCAP - XML | XCAP allows a client to read, write, and modify |
| Configuration | application configuration data, stored in XML |
| Access | format on a server. XCAP maps XML document |
| Protocol | sub-trees and element attributes to HTTP URIs, |
| | so that these components can be directly |
| | accessed by HTTP. |
| XDMC - XML | An XCAP client that manages XML documents stored |
| Document | in the network (e.g. PoC-specific documents in |
| Management | the PoC XDMS, Contact Lists in the Shared |
| Client | XDMS, etc). |
| XDMS - XML | An XCAP server that manages XML documents (e.g. |
| Document | Contact Lists) that are utilized by various |
| Management | applications. Each application has its own |
| Server | designated XDMS (e.g. PoC XDMS) |
| | and can utilize the Shared XDMS. |

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

Some embodiments herein relate specifically to the POC-3 interface in between a PoC client and a PoC server. The invention is described with reference to specific architectures and protocols. Those skilled in the art will recognize that the description is for illustration and to provide the best mode of practicing the invention. The description is not meant to be limiting. For example, while reference is made to an OMA PoC system utilizing Talk Burst Control Protocol (TBCP), other types of PTT systems using any mobile or fixed access network can also benefit from the present invention. Similarly, the present invention is equally applicable to various forms of media other than voice media as anticipated by the OMA PoC version 2 requirements related to Media Burst Control Protocol (MBCP), which is an extension to OMA PoC version 1 TBCP for the purpose of sharing audio, pictures, video and text in a PTT session. It is also envisioned that this heartbeat capability can be employed in a peer-to-peer service model, i.e. where there is no PoC server and where corresponding heartbeat messages and associated timers are implemented in each PoC client.

Likewise, reference is made to PTT sessions, while the present invention can be applied to other types of sessions including: PoC sessions, simplex media sessions, and VolP conference calls where explicit floor control policies are applied such as the Binary Floor Control Protocol (BFCP) being defined by the IETF working group “Centralized Conferencing” (xcon): http://www.ietf.org/html.charters/xcon-charter.html, which is hereby incorporated by reference. It can even be envisioned that an implicit heartbeat as presented in the present invention can be integrated with a full-duplex VolP service (with no floor control explicitly exposed to the user and heartbeat triggered by initial call setup) merely for the reason to improve the user experience in situations where application connectivity loss may occur and as such have the VolP Server, e.g. start buffering data on behalf of the listener (action 1 in present invention) or update other participants of missing user/gracefully tear down call (action 3 in present invention) based on lack of acknowledgements in the form of control and/or media packets.

In addition, embodiments of the present invention provide methods for applying repetitive control messages such as TBCP_REQUEST messages, TBCP_IDLE messages, and TBCP_TAKEN messages during a Talk Burst. These messages may, in turn, be acknowledged with TBCP_GRANTED messages and TBCP_ACK messages respectively so that an enhanced PoC server and PoC client remain interoperable with a standard OMA PoC server and PoC client. In addition, method may provide more efficient discovery of connectivity loss when matched with enhanced PoC servers and PoC clients.

In other embodiments, methods utilize existing OMA PoC version 1 User Plane timers and new timers in a PoC server to coverage conditions including:

1) “Start Buffering Media”—This action enables a PoC server to buffer media for listener if a new T32 “Start Buffering” timer expires due to lack of acknowledgements based on repetitive control messages such as TBCP_TAKEN messages. Buffered media may be released when an acknowledgement is successfully received from a listener.

2) “Bring PoC session to IDLE State”—This action enables a PoC server to bring a session to an IDLE state when either existing T1 (End of RTP media—Talker) timer expires due to lack of media from talker or when new T33 (End RTP media—Listener) timer expires due to lack of TBCP_ACK messages from listener based on repetitive control messages such as TBCP_TAKEN messages. By setting existing T13 (End of RTP media) timer in a talker PoC client and existing T11 (Cumulative TBCP_REQUEST message) timer in a listener PoC client to the same value as T1 and T33 (End of RTP media—Listener) timers, a graceful procedure for bringing a PoC session to IDLE state is achieved regardless of whether any PoC clients receive a TBCP_IDLE message from a PoC server. Note further that the use of this action on expiry of T33 may preferably be limited to 1-to-1 PoC sessions as 1-to-many PoC sessions should continue even if one listener experiences loss of media.

3) “Declare User as Unreachable”—This action enables a PoC server to declare a user as unreachable when either existing T4 (Inactivity) timer expires due to lack of Talk Bursts or when new T34 (Inactivity—Listener) timer expires due to lack of TBCP_ACK messages from listener based on repetitive control messages such as TBCP_TAKEN messages. By setting associated new T31 (Inactivity—Listener) s to the same value as T4 and T34 (Inactivity—Listener) timers, a graceful procedure for removing a PoC client from a PoC session is achieved regardless of whether an expelled PoC client receives a SIP_BYE message. Note that for 1-to-many PoC sessions, any remaining participants may continue a PoC session and be notified through the Conference State Event Package that an expelled PoC client is no longer in the PoC session. As may be appreciated, in a 1-to-1 PoC session, the PoC session will be terminated for both parties if one PoC client is expelled.

Other actions in PoC server than the three above may be envisioned based on lack of heartbeat from a PoC client, such as updating the presence status on behalf of PoC client, inviting same user on alternative SIP URI and/or device id, etc.

The following figures use similar heartbeat procedures and same timer lengths on both the talker and listener side. However, this is not intended as a limitation of embodiments of the present invention. For example, it may be decided in a deployment embodiment to enable only a heartbeat on a talker side and leave the listener side as per standard OMA PoC or to have different timer expiry for talker vs. listener for same action (“Start Buffering Media”, “Bring PoC session to IDLE state” and “Declare User as not Reachable”/“Teardown Call”). In addition, timer thresholds may be expressed in various ways. That is, it is possible to express timer thresholds as regular timers meaning the duration within a Talk Burst since last request for acknowledgement (this method is used in the detailed description below). It is also possible to set a threshold in the form of number of consecutive lost acknowledgements independent of Talk Burst. Any combination of two threshold settings may apply in a same deployment embodiment. In one embodiment, a deployment enables only one or two of the three defined actions in a specific deployment without departing from the present invention. Finally, the following figures illustrate embodiments of the present invention as applied to a 1-to-1 PoC session. However, embodiments may be equally applied to 1-to-many PoC sessions, i.e. group calls with multiple listeners.

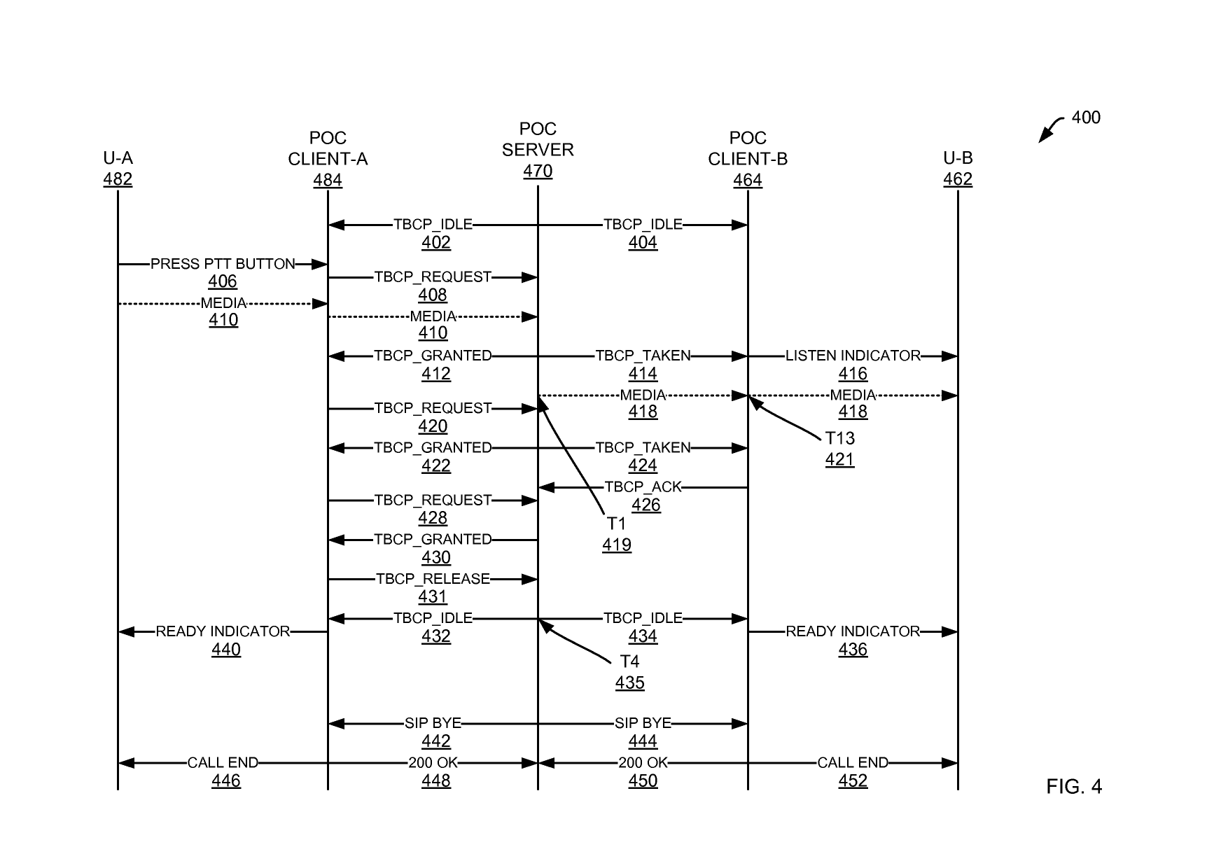

FIG. 4 is an illustrative dataflow 400 for a Talk Burst in a 1-to-1 PoC session applying lazy-lock mode and experiencing no loss of connectivity on either side in accordance with embodiments of the present invention. The dataflow begins when PoC server 470 sends TBCP_IDLE messages 402 and 404 to all participants (i.e. PoC client-A 484 and PoC client-B 464) to signal that the floor is available. User-A 482 presses a PTT button 406 to indicate a desire to take the floor and begins speaking 410. PoC client-A 484, utilizing a Lazy-lock mode, sends a TBCP_REQUEST message 408 to PoC server 470 and forwards media 410 to PoC server 470 before receiving a grant message. PoC server 470 receives TBCP_REQUEST message 408 and verifies that the floor is still available for streaming media from PoC client-A 484 to PoC client-B 464. If the floor is available, PoC server 470 then responds with a TBCP_GRANTED message 412 to PoC client-A 484. At substantially the same time, PoC server 470 sends TBCP_TAKEN message 414 to PoC client-B 464 followed by media 418. In some embodiments, PoC client-B may start T13 (End of TRP media) timer 421. In some embodiments T13 (End of RTP media) timer is set to approximately 4 seconds. T13 (End of RTP media) timer provides a trigger for determining how long to wait for media as determined from the last media received. In some embodiments, PoC server may process media from a sending PoC client before forwarding to receiving PoC client. PoC server starts T1 (End of RTP media) timer 419 that governs how long PoC server 470 will maintain the floor allocation without receiving media from PoC client-A 484. In some embodiments T1 (End of RTP media—Talker) timer is set to approximately 4 seconds. T1 (End of RTP media—Talker) timer 419 is re-started every time new media is received from PoC client-A 484. FIG. 4 illustrates an application of a standard definition of T1 (End of RTP media) timer. In this example, a T1 (End of RTP media—Talker) timer is restarted whenever media is received. One purpose of a T1 (End of RTP media—Talker) timer is to avoid mistakenly granting floor control to a participant and to prevent a user from abusing floor control privilege. However, in an embodiment of the present invention as an implicit heartbeat for any full-duplex VolP service, it is seen advantageous to restart a T1 (End of RTP media—Talker) timer only when sending a successful TBCP_GRANTED message after receiving a TBCP_REQUEST message. In that embodiment, parties may interrupt and speak in regardless of whether or not a talker releases the floor. One benefit of this embodiment is that a talker may keep the floor whether or not he is actually talking and, therefore, is not limited by a standard T1 (End of RTP media—Talker) timer expiry due to media not being sent.

In the embodiment illustrated, talker PoC client-A 484 continues to send TBCP_REQUEST messages 420 and 428 at regular intervals. With each TBCP_REQUEST message, PoC server 470 responds with a renewed TBCP_GRANTED message 422 and 430 respectively. PoC client-A 484 utilizes these messages and responses as a heartbeat during a Talk Burst and may formulate appropriate actions based on a number of missed heartbeats (e.g. bring local instance of PoC session to IDLE message or Call Ended state). In some embodiments, a TBCP_REQUEST message is sent at a selected rate in the range of approximately 0 to 5 seconds, more preferably approximately every 2 seconds. In like manner, PoC server 470 may be configured to send a TBCP_TAKEN message 424 during the Talk Burst to listener PoC client-B 464. In some embodiments, a TBCP_TAKEN message utilized for a heartbeat is sent at a selected rate in the range of approximately 0 to 5 seconds, more preferably approximately every 2 seconds. Further, TBCP_TAKEN messages may include a request for acknowledgement via TBCP_ACK message 426 from PoC client-B 464. This request may be achieved, in some embodiments, by applying the OMA PoC User Plane specification bit pattern 10010 in the subtype field of the TBCP_TAKEN message to indicate that the PoC server expects an acknowledgement in reply. In this manner legacy PoC servers may utilized embodiments of the present invention without being specifically configured or reconfigured. A PoC server utilizing a heartbeat as described herein may apply actions in the form of “Start Buffering Media,” “Bring PoC session to IDLE state,” or “Declare Listener as Unreachable” depending on how many consecutive acknowledgements that have been lost. Note that the repetitive control messages such as TBCP_TAKEN messages may be applied independently from a PoC client heartbeat on the talker side using TBCP_REQUEST messages.

At some point in time, PoC client-A 484 may send a TBCP_RELEASE message 431 to PoC server 470. Upon receiving TBCP_RELEASE message 431, PoC server 470 sends TBCP_IDLE messages 432 and 434 to all participants, whereupon PoC clients may send ready indicators 440 and 436 to their respective users. A T4 (Inactivity) timer 435 may be started by PoC server 470. In some embodiments T4 (Inactivity) timer is set to approximately 30 seconds. A T4 (Inactivity) timer may trigger a PoC server to end a session for an extended IDLE state condition. When T4 (Inactivity) timer 435 expires, PoC server 470 ends the session by sending SIP BYE messages 442 and 444 to all participants, whereupon the participants return acknowledgement (200 OK) messages to PoC server 470. Calls are then ended 446 and 452.

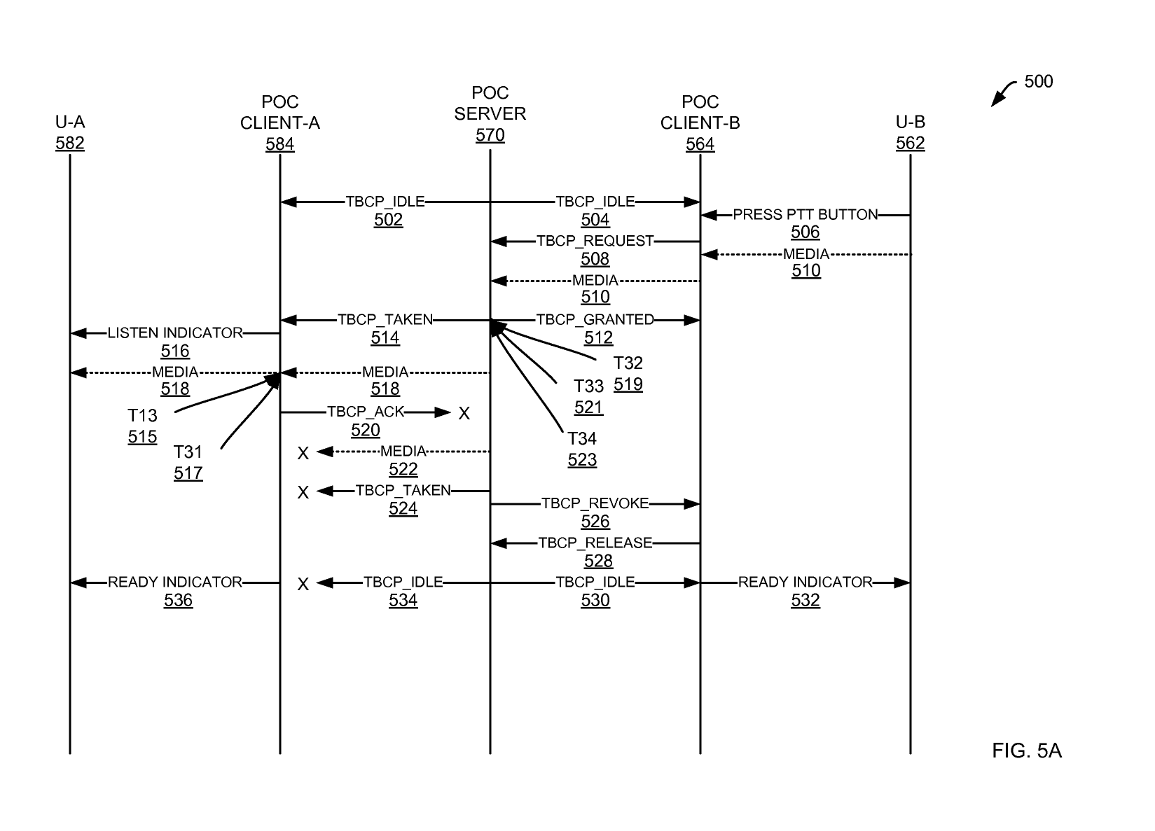

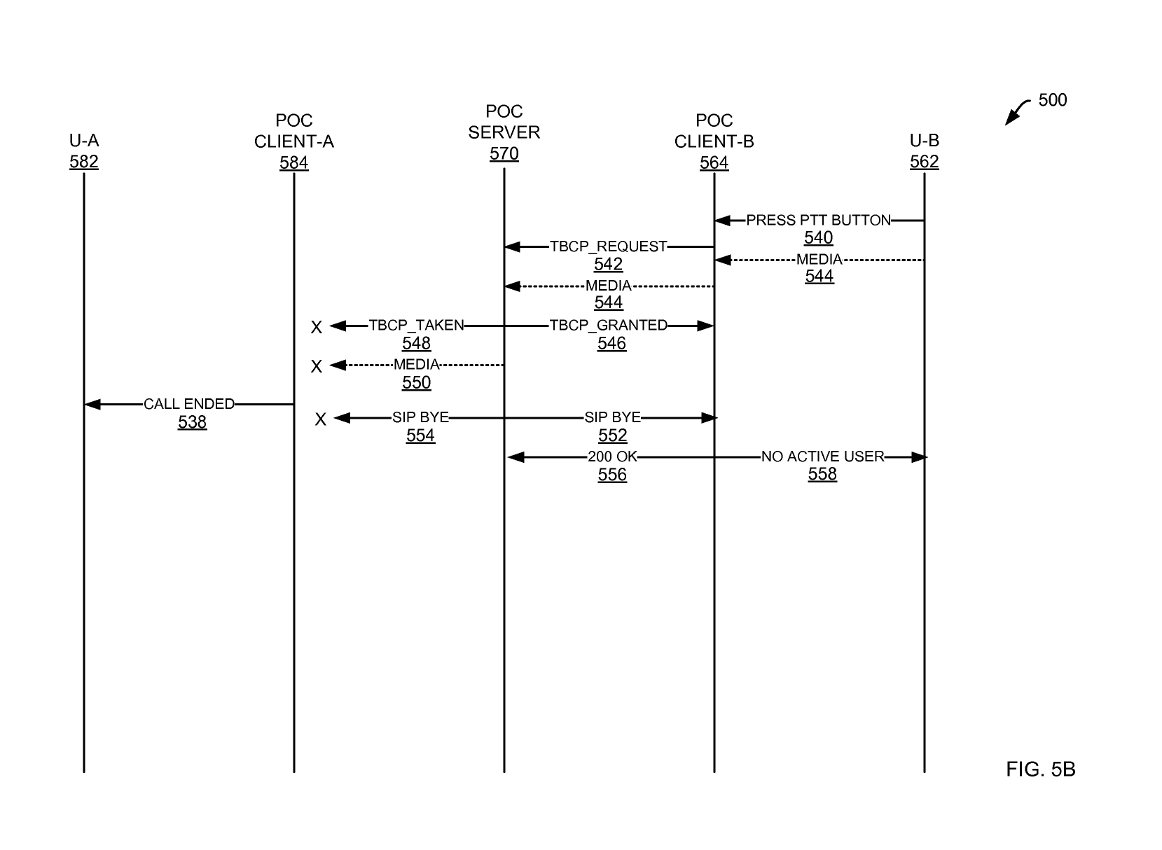

FIGS. 5A-B illustrate a dataflow 500 for a Talk Burst in a 1-to-1 PoC session applying lazy-lock mode and experiencing loss of connectivity on listener side after TBCP_TAKEN message is received in accordance with embodiments of the present invention. Embodiments of the present invention introduce at least four new timers including: T31 (Inactivity—Listener); T32 (Start Buffering) timer; T33 (End of RTP media—Listener) timer; and T34 (Inactivity—Listener) timer. In some embodiments, a T31 (Inactivity—Listener) is a complementary timer to T4 (Inactivity) timer of a PoC server. T31 (Inactivity—Listener) runs as long as no media or floor control messages are received at a PoC client. In some embodiments, a T31 (Inactivity—Listener) is set to a value approximately equal to a T4 (Inactivity) timer. Setting a T31 (Inactivity—Listener) may be achieved in any number of ways without departing from the present invention. A PoC server may set the value of the T31 (Inactivity—Listener) to the same as a T4 (Inactivity) timer by sending the T4 (Inactivity) timer value to all PoC clients either at a SIP initiation phase (SIP INVITE, 200 OK) or at Talk Burst Initiation phase (TBCP_TAKEN message, TBCP_GRANTED message). A T31 (Inactivity—Listener) value may also be set as an Over-The-Air (OTA) provisioning parameter in the User Equipment (UE) through its DM capabilities. Additionally, a T31 (Inactivity—Listener) value may be set as a local parameter setting, e.g., during a software build or install process. In some embodiments, a T31 (Inactivity—Listener) value is in the range of approximately 15 to 45 seconds, more preferably approximately 30 seconds. Expiry of a T31 (Inactivity—Listener) will, in some embodiments, trigger a PoC server to declare a user as unreachable and, in case of 1-to-1 PoC session, end the session.

In some embodiments, a new T32 (Start buffering) timer is optionally implemented in a PoC server to avoid media losses on a downlink towards a listener, e.g. PoC client-A 584, in the event that a cell, routing area or inter-SGSN handover is occurring in the access network. Embodiments include a separate T32 (Start buffering) timer for every listener and an associated buffer in the PoC server for every listener. A T32 (Start buffering) timer should not be set to a value so low as to adversely affect access networks having buffer and retransmission issues. In some embodiments, a T32 (Start buffering) timer is set to a value approximately equal to a T1 (End of RTP media—Talker) timer and a T13 (End of RTP media) timer. In some embodiments utilizing a GPRS network, a T32 (Start buffering) timer value is in the range of approximately 0 to 8 seconds, more preferably approximately 4 seconds. For example, a T32 (Start buffering) timer having a value of approximately 4 seconds means that a PoC server begins buffering media for 4 seconds after sending the last unacknowledged TBCP_TAKEN message. The buffer would be released after receiving a TBCP_ACK message whereupon T32 (Start buffering) timer may be reset after sending out a next TBCP_TAKEN message. In some embodiments, T32 (Start buffering) timer may be configured to stop when a Talk Burst ends.

In some embodiments, a new T33 (End of RTP media—Listener) timer may be configured to operate within a PoC server. A T33 (End of RTP media—Listener) timer is similar in nature and value as a standard T1 (End of RTP media—Talker) timer. In some embodiments, a T33 (End of RTP media—Listener) timer value is in the range of approximately 0 to 10 seconds, more preferably approximately 6 seconds. However, instead of being a single timer for an entire Talk Burst, a T33 (End of RTP media—Listener) timer may be enabled for every listener in a Talk Burst. Thus, a T33 (End of RTP media—Listener) timer may be initiated for each listening participant whenever a TBCP_TAKEN message is sent. A T33 (End of RTP media—Listener) timer may also be re-initiated when a new TBCP_TAKEN message is sent after having received a TBCP_ACK message from a previous TBCP_TAKEN message. A T33 (End of RTP media—Listener) timer may be configured to trigger a PoC server to bring a PoC session to an IDLE state upon expiry. When a T33 (End of RTP media—Listener) timer expires, a TBCP_REVOKE message may be sent to a talker PoC client, whereupon the talker PoC client may send a TBCP_RELEASE message to a PoC server. A similar action is triggered with a T3 (Stop talking grace) timer expires. In some embodiments, a PoC server may send a TBCP_IDLE message with a new option header stating that the cause was “Bad reception.” The PoC server can still maintain interoperability with standard OMA PoC clients when adding this error message as OMA PoC User Plane specification mandates that a PoC client and a PoC server shall ignore any unspecified fields in a message. As such standard OMA PoC clients will merely display a Ready state to a user rather than a Ready (Bad Reception) error message as illustrated in FIG. 5A. Note that in a user case where a listening PoC client has already received a network suspend message from the UE protocol stack and subsequently receives a network resume message, the listening PoC client may then send an update to a talking user in the form of a Ready message without an error message. In that case, a talking user may attempt to again take the floor.

In some embodiments, a new timer T34 (Inactivity—Listener) timer may be configured to operate within a PoC server. As with T33 (End of RTP media—Listener) timer, a T34 (Inactivity—Listener) timer is running for each listener. As with T4 (Inactivity) timer for whole PoC session, T34 per Listener is re-set when any media or floor control message is received from a listening PoC client. At expiry of a T34 (Inactivity—Listener) timer, a PoC server initiates the action to “Declare the listening user as Unreachable.” In 1-to-many PoC sessions, any remaining participants may continue the PoC session and only be notified through the Conference State Event Package that the unreachable user is no longer in the PoC session. In a 1-to-1 PoC session (as shown in FIG. 5), a PoC server may terminate the PoC session for both parties if one user is deemed unreachable. In some embodiments, a T34 (Inactivity—Listener) timer value is in the range of approximately 15 to 45 seconds, more preferably approximately 30 seconds, i.e. the same as T4 and T31 .

Returning to FIG. 5A, the dataflow 500 begins when PoC server 570 sends TBCP_IDLE messages 502 and 504 to all participants (i.e. PoC client-A 584 and PoC client-B 564) to signal that the floor is available. User-B 564 presses a PTT button 506 to indicate a desire to take the floor and begins speaking 510. PoC client-B 564, utilizing a Lazy-lock mode, sends a TBCP_REQUEST message 508 to PoC server 570 and forwards media 510 to PoC server 570 before receiving a grant message. PoC server 570 receives TBCP_REQUEST message 508 and verifies that the floor is still available for streaming media from PoC client-B 564 to PoC client-A 584. If the floor is available, PoC server 570 then responds with a TBCP_GRANTED message 512 to PoC client-B 564. At substantially the same time, PoC server 570 sends TBCP_TAKEN message 514 to PoC client-A 584 followed by media 518.

As noted above, PoC server 570 starts timers, T32 519, T33 521, and T34 523. In some embodiments, T32 (Start buffering) timer is in the range of approximately 0 to 8 seconds, more preferably approximately 4 seconds. In some embodiments, T33 (End of RTP media—Listener) timer is in the range of approximately 0 to 10 seconds, more preferably approximately 6 seconds. In some embodiments, T34 (Inactivity—Listener) timer is in the range of approximately 15 to 45 seconds, more preferably approximately 30 seconds. In addition, PoC client-A 584 starts timers T13 515 and T31 517. In some embodiments, T13 (End of RTP media) timer is set to approximately 6 seconds. In some embodiments, T31 (Inactivity—Listener) is in the range of approximately 15 to 45 seconds, more preferably approximately 30 seconds. At some point in time, PoC client-A 584 loses communications network connectivity. As such, TBCP_ACK message 520, media 522, and TBCP_TAKEN message 524 are dropped. As illustrated, T33 (End of RTP media—Listener) timer 521 expires when an acknowledgment from listening PoC client-A 584 is not received. In response to T33 (End of RTP media—Listener) timer expiry, PoC server 570 sends a TBCP_REVOKE message 526 to PoC client-B 564 whereupon PoC client-B 564 sends a TBCP_RELEASE message 528 to PoC server 570. PoC server 570 then sends TBCP_IDLE messages 534 and 530 to all PoC clients; however TBCP_IDLE message 534 may not be received by PoC client-A 584 due to communications network connectivity loss. PoC client-B 564, in response to TBCP_IDLE message 530 may send a ready indicator 532 to user-B 562. In addition, when T13 (End of RTP media) timer 515 expires, PoC client-A 584 may send a ready indicator 536 to user-A 582.

Continuing to FIG. 5B, at some point in time, user-B 562 may attempt to retake floor control by pressing a PTT button 540 and beginning to speak 544. PoC client-B 564, utilizing a Lazy-lock mode, sends a TBCP_REQUEST message 542 to PoC server 570 and forwards media 544 to PoC server 570 before receiving a grant message. PoC server 570 receives TBCP_REQUEST message 542 and verifies that the floor is still available for streaming media from PoC client-B 564 to PoC client-A 584. If the floor is available, PoC server 570 then responds with a TBCP_GRANTED message 546 to PoC client-B 564. At substantially the same time, PoC server 570 sends TBCP_TAKEN message 548 to PoC client-A 584 followed by media 550. In this instance, however, PoC client-A 584 is not connected with the communications network and TBCP_TAKEN message 548 and media 550 are dropped. Upon expiry of T34 (Inactivity—Listener) timer 523, PoC server 570 terminates the session by sending SIP BYE messages 552 and 554 to all PoC clients. PoC client-B 564 returns acknowledgement (200 OK) message 556 to PoC server 570 and forwards a no active user message 558 to user-B 562. In addition, upon expiry of T31 (Inactivity—Listener) 517, PoC client-A 584 sends a call ended message 538 to user-A 582 due to lack of activity. In this manner, calls are ended more gracefully over conventional methods.

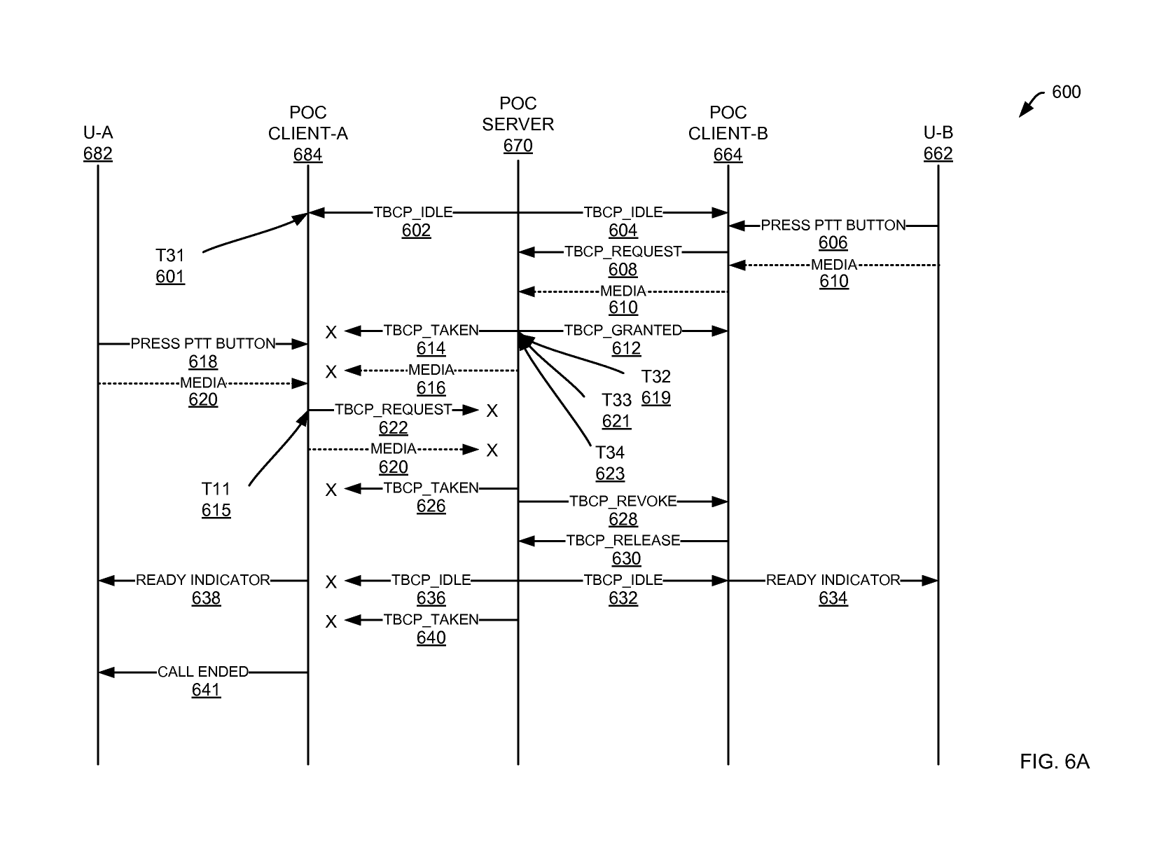

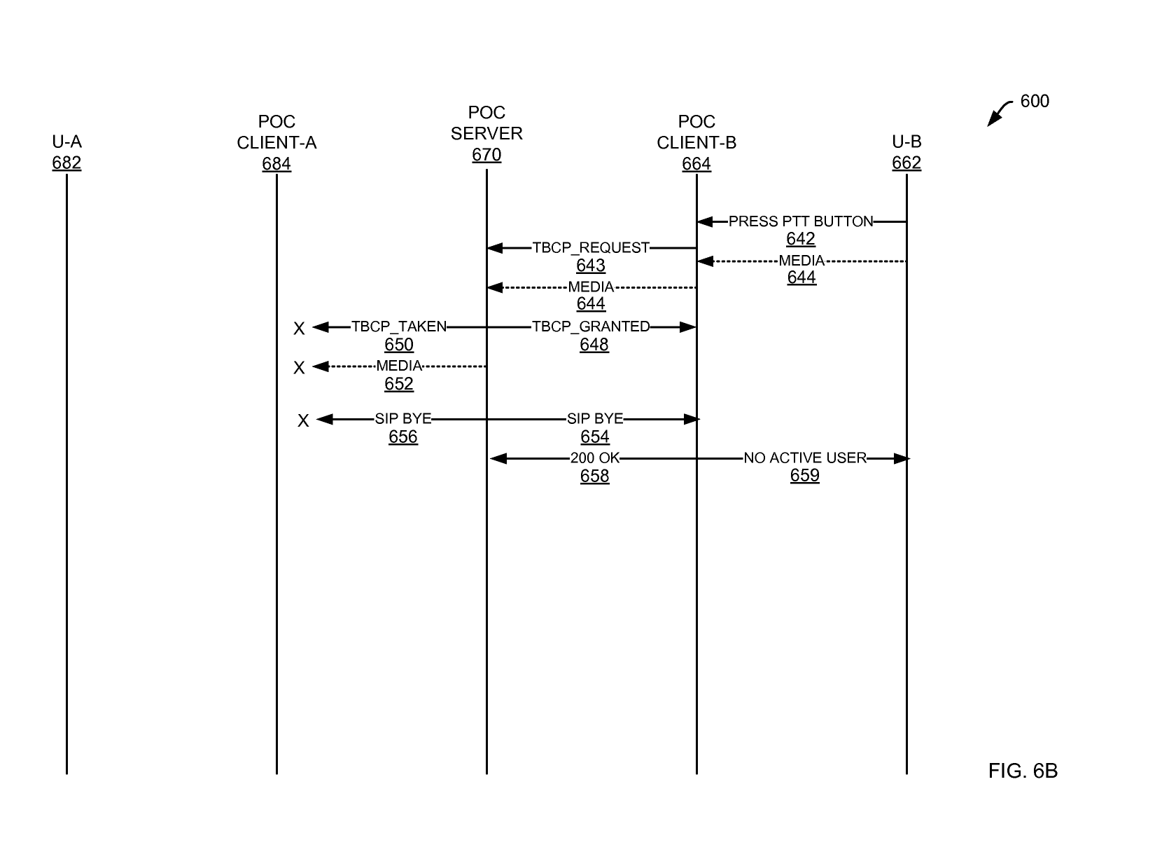

FIGS. 6A-B illustrate a dataflow 600 for a Talk Burst in a 1-to-1 PoC session applying lazy-lock mode and experiencing loss of connectivity on listener side before TBCP_TAKEN message is received in accordance with embodiments of the present invention. This scenario is slightly different in that PoC client-A is not aware that the floor is taken and allocated to PoC client-B and as such user-A may press the PTT button and PoC client-A send a TBCP_REQUEST message. A standard T11 (Cumulative TBCP_REQUEST message) timer is used in PoC client-A to timeout the attempt to take the floor and go back to Ready (Network Busy) state. As such T11 takes the role of T13 in FIG. 5 and has the same default value of 6 seconds.

Turning to FIG. 6A, the dataflow 600 begins when PoC server 670 sends TBCP_IDLE messages 602 and 604 to all participants (i.e. PoC client-A 684 and PoC client-B 664) to signal that the floor is available. When PoC client-A 684 receives TBCP_IDLE message 602, PoC client-A 684 starts timer T31 601. In some embodiments, T31 (Inactivity—Listener) is in the range of approximately 15 to 45 seconds, more preferably approximately 30 seconds. Before PoC client-A 684 communicates any further with PoC server 670, PoC client-A 684 loses connectivity with the communications network. User-B 664 presses a PTT button 606 to indicate a desire to take the floor and begins speaking 610. PoC client-B 664, utilizing a Lazy-lock mode, sends a TBCP_REQUEST message 608 to PoC server 670 and forwards media 610 to PoC server 670 before receiving a grant message in accordance with Lazy-lock methods. PoC server 670 receives TBCP_REQUEST message 608 and verifies that the floor is still available for streaming media from PoC client-B 664 to PoC client-A 684. If the floor is available, PoC server 670 then responds with a TBCP_GRANTED message 612 to PoC client-B 664. At substantially the same time, PoC server 670 sends TBCP_TAKEN message 614 to PoC client-A 684 followed by media 616. In this case, however, neither TBCP_TAKEN message 614 nor media 616 are received by PoC client-A 684 due to loss of connectivity.

After granting the floor, PoC server 670 starts timers, T32 619, T33 621, and T34 623. In some embodiments, T32 (Start buffering) timer is in the range of approximately 0 to 8 seconds, more preferably approximately 4 seconds. In some embodiments, T33 (End of RTP media—Listener) timer is in the range of approximately 0 to 10 seconds, more preferably approximately 6 seconds. In some embodiments, T34 (Inactivity—Listener) timer is in the range of approximately 15 to 45 seconds, more preferably approximately 30 seconds. At some point in time, user-A 682 may wish to talk. User-A 682 press PTT button 618 and begins to talk 620, whereupon PoC client-A 684 sends a TBCP_REQUEST message 622 and media 620 to PoC server 670, which are dropped. In addition, PoC client-A 684 starts T11 (Cum. TBCP_REQUEST) timer 615. In some embodiments, T11 (Cum. TBCP_REQUEST) timer is set to approximately 6 seconds. PoC server 670 sends a TBCP_TAKEN message 626 to PoC client-A 684, which is dropped. As illustrated, T33 (End of RTP media—Listener) timer 621 expires when an acknowledgment from listening PoC client-A 684 is not received. In response to T33 (End of RTP media—Listener) timer expiry, PoC server 670 sends a TBCP_REVOKE message 628 to PoC client-B 664 whereupon PoC client-B 664 sends a TBCP_RELEASE message 630 to PoC server 670. PoC server 670 then sends TBCP_IDLE messages 632 and 636 to all PoC clients; however TBCP_IDLE message 636 may not be received by PoC client-A 684 due to communications network connectivity loss. PoC client-B 664, in response to TBCP_IDLE message 632 may send a ready indicator 634 to user-B 664. In addition, when T31 (Inactivity—Listener) 601 expires, PoC client-A 684 may send a ready indicator 641 to user-A 682.

Continuing to FIG. 6B, at some point in time, user-B 662 may attempt to retake floor control by pressing a PTT button 642 and beginning to speak 644. PoC client-B 664, utilizing a Lazy-lock mode, sends a TBCP_REQUEST message 643 to PoC server 670 and forwards media 644 to PoC server 670 before receiving a grant message. PoC server 670 receives TBCP_REQUEST message 642 and verifies that the floor is still available for streaming media from PoC client-B 664 to PoC client-A 684. If the floor is available, PoC server 670 then responds with a TBCP_GRANTED message 648 to PoC client-B 664. At substantially the same time, PoC server 670 sends TBCP_TAKEN message 650 to PoC client-A 684 followed by media 652. In this instance, however, PoC client-A 684 is not connected with the communications network and TBCP_TAKEN message 650 and media 652 are dropped. Upon expiry of T34 (Inactivity—Listener) timer 623, PoC server 670 terminates the session by sending SIP BYE messages 654 and 656 to all PoC clients. PoC client-B 664 returns acknowledgement (200 OK) message 658 to PoC server 670 and forwards a no active user message 659 to user-B 662. In this manner, calls are ended more gracefully over conventional methods.

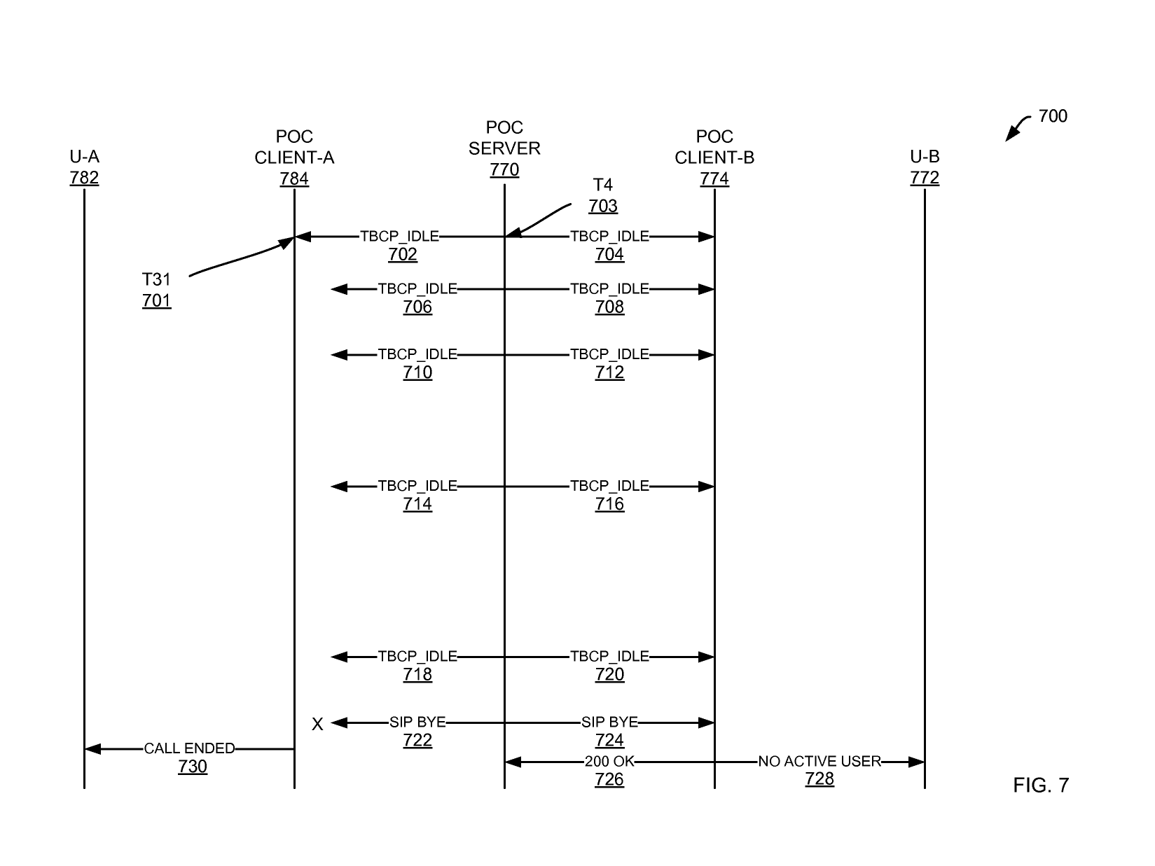

FIG. 7 is an illustrative dataflow 700 for a Talk Burst in a 1-to-1 PoC session applying lazy-lock mode and experiencing loss of connectivity in IDLE state until PoC server T4 (Inactivity) timer expiries in accordance with embodiments of the present invention. The dataflow 700 begins when PoC server 770 sends TBCP_IDLE messages 702 and 704 to all PoC clients. PoC server 770 starts T4 (Inactivity) timer 703 on sending TBCP_IDLE message 702. In addition, PoC client-A 784 starts T31 (Inactivity—Listener) 701 on receiving TBCP_IDLE message 702. In some embodiments, the value of the T4 (Inactivity) timer and the T31 (Inactivity—Listener) are substantially the same. In some embodiments, the value of the T4 (Inactivity) timer and the T31 (Inactivity—Listener) is in the range of approximately 15 to 45 seconds, more preferably approximately 30 seconds. Utilizing a heartbeat in embodiments of the present invention, TBCP_IDLE messages continue to be sent to all PoC clients. Thus, TBCP_IDLE messages 708 to 720 are sent to all PoC clients. In this example, messages sent to PoC client-A 784 are dropped. In some embodiments, a heartbeat is sent at a selected rate in the range of approximately 0 to 5 seconds, more preferably approximately 2 seconds. That is, in one embodiment, a set of TBCP_IDLE messages are sent to all PoC clients approximately every 2 seconds. When T4 (Inactivity) timer 703 expires, PoC server 770 terminates the session by sending SIP BYE messages 722 and 724. Similarly, when T31 (Inactivity—Listener) 701 expires, PoC client-A 784 ends the local instance of the PoC session 730 in PoC client-A 784. In this manner, the session is ended at substantially the same time at both the server end and the disconnected client end despite an extended loss of connection.

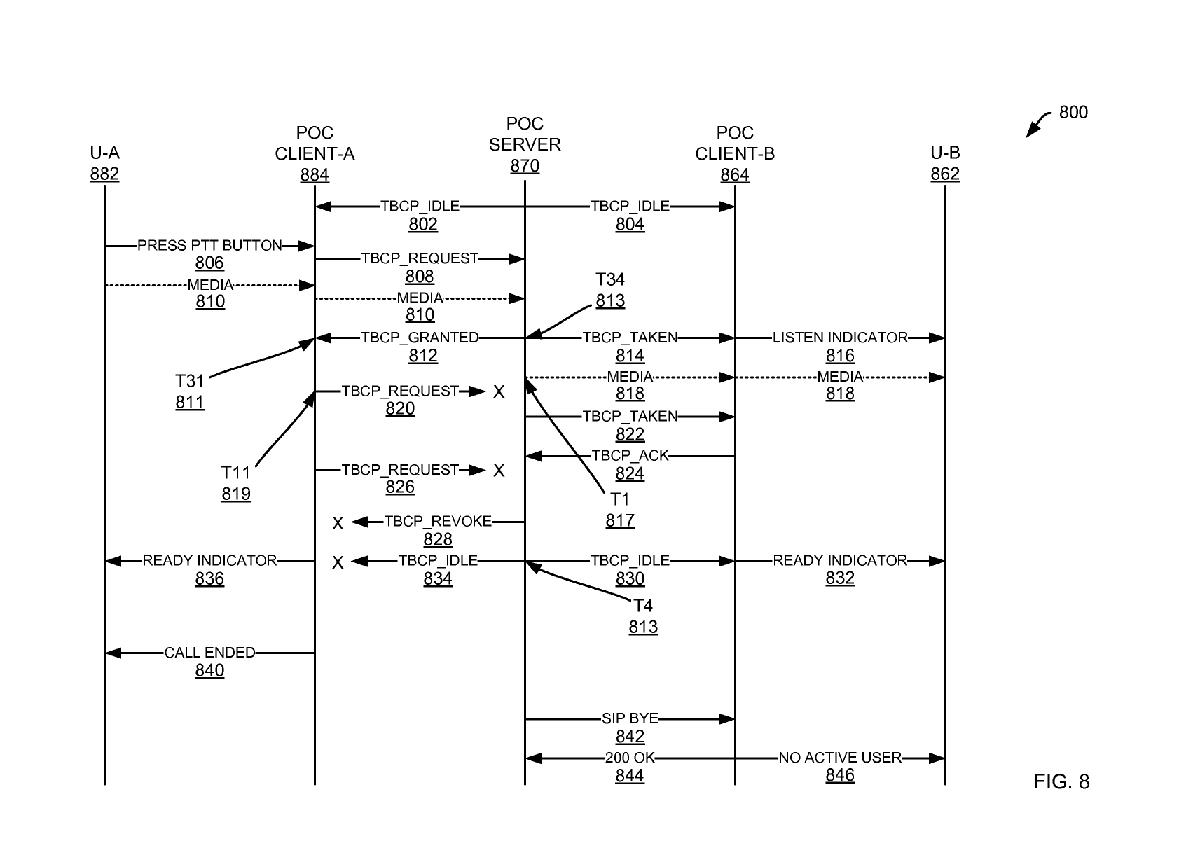

FIG. 8 is an illustrative dataflow 800 for a Talk Burst in a 1-to-1 PoC session applying lazy-lock mode and experiencing loss of connectivity on a talker side after TBCP_GRANTED message is received in accordance with embodiments of the present invention. The dataflow 800 begins when PoC server 870 sends TBCP_IDLE messages 802 and 804 to all participants (i.e. PoC client-A 884 and PoC client-B 864) to signal that the floor is available. User-A 882 presses a PTT button 806 to indicate a desire to take the floor and begins speaking 810. PoC client-A 884, utilizing a Lazy-lock mode, sends a TBCP_REQUEST message 808 to PoC server 870 and forwards media 810 to PoC server 870 before receiving a grant message. PoC server 870 receives TBCP_REQUEST message 808 and verifies that the floor is still available for streaming media from PoC client-A 884 to PoC client-B 864. If the floor is available, PoC server 870 then responds with a TBCP_GRANTED message 812 to PoC client-A. When TBCP_GRANTED message 812 is sent, PoC server 870 starts T34 (Inactivity—Listener) timer. In some embodiments, T34 (Inactivity—Listener) timer is in the range of approximately 15 to 45 seconds, more preferably approximately 30 seconds. When TBCP_GRANTED message 812 is received, PoC client-A 884 starts T31 (Inactivity—Listener) 811. In some embodiments T31 (Inactivity—Listener) is in the range of approximately 15 to 45 seconds, more preferably approximately 30 seconds. At substantially the same time, PoC server 870 sends TBCP_TAKEN message 814 to PoC client-B 864 followed by media 818. When media 818 is sent, PoC server starts T1 (End of RTP media—Talker) timer 817. In some embodiments, T1 (End of RTP media—Talker) timer is set to approximately 6 seconds. After receiving TBCP_TAKEN message 814, PoC client-B 864 sends listen indicator 816 along with media 818 to user-B 862.

At some point in time, PoC client-A 884 goes out of coverage and relies on T11 (Cumulative TBCP_REQUEST message) timer to roll back to Ready (Network Busy) state and T31 (Inactivity—Listener) to end the call. Thus, when TBCP_REQUEST message 820 is sent (and subsequently dropped), PoC client-A starts T11 (Cum. TBCP_REQUEST) timer 819. In some embodiments, T11 (Cum. TBCP_REQUEST) timer is set to approximately 6 seconds. PoC client-A 884 on receiving no acknowledgement from PoC server 870, sends an additional TBCP_REQUEST message 826 to PoC server 870. When T11 (Cum. TBCP_REQUEST) timer 819 expires, PoC client-A 884 will return a ready indicator 836 to user-A 882. When T31 (Inactivity—Listener) 811 expires, PoC client-A 884 ends the local instance of the PoC session 840 in PoC client-A 884.

While PoC client-A 884 is out of communications network, PoC server sends TBCP_TAKEN message 822 to PoC client-B 864, whereupon PoC client-B 864 returns TBCP_ACK message 824 to PoC server 870. When T1 (End of RTP media—Talker) timer 817 expires, PoC server 870 revokes the floor from PoC client-A 884. PoC server 870 then moves the session to IDLE state by sending TBCP_IDLE messages 830 and 834 to all participants. PoC server 870 further starts T4 (Inactivity) timer 831 when sending TBCP_IDLE messages. In some embodiments, T4 (Inactivity) timer is set to approximately 30 seconds. When T4 (Inactivity) timer 831 expires, PoC server 870 tears down the session by sending SIP BYE message 842 to PoC client-B 864, whereupon PoC client-B 864 returns acknowledgement (200 OK) message 844 to PoC server 870. PoC client-B 846 then indicates 846 to user-B 862 that no active user is available.

One difference in the illustrated dataflow 800 over FIG. 6 is that T11 (Cum. TBCP_REQUEST) timer 819 is restarted after receiving the first TBCP_GRANTED message 812 and sending the second TBCP_REQUEST message 820, where FIG. 6 T11 (Cum. TBCP_REQUEST) timer was started before any grant. Additionally, T31 (Inactivity—Listener) 811 is restarted at reception of TBCP_GRANTED message 812 (the last media of floor control message received), where FIG. 6 T31 (Inactivity—Listener) was started before any grant. PoC server 870 may utilize a standard T1 (End of RTP media—Talker) timer 817 to bring the PoC session down to IDLE state when not receiving any media from PoC client-A 884 and may further utilize a standard T4 (Inactivity) timer 813 to bring down the PoC session when no new requests for Talk Bursts are sent by either PoC client-A 884 or PoC client-B 864. If user-B 862 makes a request for floor control in an interval between these two timeouts (not shown in FIG. 8), then a similar sequence as described at the end of FIGS. 5 and 6 would occur (i.e. the T34 (Inactivity Listener) timer would eventually expire causing the PoC server to declare PoC client-A as unreachable and subsequently end the PoC session.

While this invention has been described in terms of several preferred embodiments, there are alterations, permutations, and equivalents, which fall within the scope of this invention. It should also be noted that there are many alternative ways of implementing the methods and apparatuses of the present invention. Although various examples are provided herein, it is intended that these examples be illustrative and not limiting with respect to the invention. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for providing a heartbeat during a communication session utilizing a plurality of repetitive control messages in a communications network, the communication session configured for delivering a media stream, the method comprising:
transmitting the plurality of repetitive control message between a plurality of participants in the communication session at a selected rate corresponding with the heartbeat, wherein the plurality of participants includes at least one talking participant and at least one listening participant, and wherein the plurality of repetitive control messages provide at least updated status for the plurality of participants.

2. The method of claim 1 further comprising:
setting a plurality of timers corresponding with the plurality of repetitive control messages; and
if any of the plurality of timers expires before an acknowledgement of any of the plurality of repetitive control messages is received from the plurality of participants, triggering one or more of a plurality of actions to update the plurality of participants of a change in status for the communication session.

3. The method of claim 1 wherein the selected rate is in the range of approximately 0 to 5 seconds.

4. The method of claim 3 wherein the selected rate is approximately 2 seconds.

5. The method of claim 2 wherein the communications network is selected from the group consisting of: a server based network, a peer-to-peer network, a PoC network, and a VolP enabled network.

6. The method of claim 5 wherein the heartbeat operates as in explicit floor control environment for the communication session selected from the group consisting of: a Push-To-Talk (PTT) session, a PTT-over-Cellular (PoC) session, a simplex media session, a Voice-over-IP (VoIP) conference call session.

7. The method of claim 5 wherein the heartbeat operates in an implicit floor control environment when the communication session is a full-duplex VolP session.

8. The method of claim 6 wherein the repetitive control messages are selected from the group consisting of: a repetitive TBCP_REQUEST message, a repetitive TBCP GRANTED message, a repetitive TBCP_TAKEN message, a repetitive TBCP_ACK message, and a repetitive TBCP_IDLE message.

9. The method of claim 6 wherein the plurality of timers is selected from the group consisting of: a plurality of OMA PoC version 1 User Plane timers, a T31 (Inactivity—Listener) timer on a listening PoC client, a T32 (Start buffering) timer on a PoC server, a T33 (End of RTP media—Listener) timer on the PoC server, and a T34 (Inactivity—Listener) timer on the PoC server.

10. The method of claim 9 wherein,
the T31 (Inactivity—Listener) is set to a value approximately equal to a T4 (Inactivity) timer on the PoC server, wherein
the T32 (Start buffering) timer is set to a value approximately equal to a T1 (End of RTP media—Talker) timer on the PoC server and a T13 (End of RTP media) timer on the listening PoC client, wherein
the T33 (End of RTP media—Listener) timer is set to a value approximately equal to a T1 (End of RTP media—Talker) timer on the PoC server, a T11 (Cumulative TBCP_REQUEST) timer on a talking PoC client, and a T13 (End of RTP media) timer on the listening PoC client, and wherein
the T34 (Inactivity—Listener) timer is set to a value approximately equal to a T4 (Inactivity) timer on the PoC server and to the T31 (Inactivity—Listener).

11. The method of claim 10 wherein the plurality of actions includes:
a) if the T32 (Start buffering) timer expires due to not receiving the acknowledgement buffering the media stream on a server on behalf of the at least one listening participant, and
releasing the media stream when a next acknowledgement is successfully received from the talking participant;
b) bringing the communication session to an IDLE state by the server in a 1-to-1 communication session when either a T1 (End of RTP media—Talker) timer expires due to lack of media stream from the talking participant or when the T33 (End RTP media—Listener) timer expires due to lack of a TBCP_ACK message from the at least one listening participant based on the repetitive TBCP_TAKEN messages, and
setting a plurality associated timers in each of the plurality of participants, wherein the plurality of associated timers is selected from the group consisting of: a T13 (End of RTP media) timer in the talking participant, and a T11 (Cumulative TBCP_REQUEST) timer in the at least one listening participant, wherein the T11 (Cumulative TBCP_REQUEST) timer is set to a value equivalent to the T1 (End of RTP media—Talker) timer and the T13 (End of RTP media) timer; and
c) declaring the at least one listening participant as not reachable by the server when either a T4 (Inactivity) timer expires due to lack of the media stream or the T34 (Inactivity—Listener) timer expires due to lack of the TBCP_ACK message from the at least one listening participant based on the repetitive TBCP_TAKEN message,
setting the T31 (Inactivity—Listener) to a value equivalent to the T4 (Inactivity) timer and the T34 (Inactivity—Listener) timer, and
removing the at least one listening participant from the communication session.

12. The method of claim 1 wherein the media stream is selected from the group consisting of: audio, pictures, video, and text.

13. A method for providing a floor control-based heartbeat during a Push-to-Talk-over-Cellular (PoC) session utilizing a plurality of repetitive control messages in a PoC network, the PoC session configured for delivering a media stream, the method comprising:
sending the plurality of repetitive control messages between a PoC server and a plurality of PoC clients in the PoC session during a single talk burst at a rate corresponding with the heartbeat, wherein the plurality of PoC clients includes at least one talking PoC client and at least one listening PoC client, and wherein the plurality of repetitive control messages provide at least updated status for the plurality of PoC clients.

14. The method of claim 13 further comprising:
setting a plurality of timers corresponding with the plurality of repetitive control messages;
if any of the plurality of timers expires before an acknowledgement of any of the plurality of repetitive control messages is received from the plurality of PoC clients,
triggering one or more of a plurality of actions to update the plurality of PoC clients of a change in status for the PoC session.

15. The method of claim A1 wherein the repetitive control messages are selected from the group consisting of: a repetitive TBCP_REQUEST message, a repetitive TBCP GRANTED message, a repetitive TBCP_TAKEN message, a repetitive TBCP_ACK message, and a repetitive TBCP_IDLE message.

16. The method of claim 13 wherein the rate is in the range of approximately 0 to 5 seconds.

17. The method of claim 16 wherein the rate is approximately 2 seconds.

18. The method of claim 13 wherein the plurality of timers is selected from the group consisting of: h, a T31 (Inactivity—Listener) timer on the at least one listening PoC client, a T32 (Start buffering) timer on the PoC server, a T33 (End of RTP media—Listener) timer on the PoC server, and a T34 (Inactivity—Listener) timer on the PoC server.

19. The method of claim 18 wherein,
the T31 (Inactivity—Listener) is set to a value approximately equal to a T4 (Inactivity) timer on the PoC server, wherein
the T32 (Start buffering) timer is set to a value approximately equal to a T1 (End of RTP media—Talker) timer on the PoC server and a T13 (End of RTP media) timer on the at least one listening PoC client, wherein
the T33 (End of RTP media—Listener) timer is set to a value approximately equal to a T1 (End of RTP media—Talker) timer on the PoC server, a T11 (Cumulative TBCP_REQUEST) timer on the at least one talking PoC client, and a T13 (End of RTP media) timer on the listening PoC client, and wherein
the T34 (Inactivity—Listener) timer is set to a value approximately equal to a T4 (Inactivity) timer on the PoC server and to the T31 (Inactivity—Listener).

20. The method of claim 19 wherein the plurality of actions includes:
a) if the T32 (Start buffering) timer expires due to not receiving the acknowledgement, buffering the media stream on the PoC server on behalf of the at least one listening PoC client, and
releasing the media stream when a next acknowledgement is successfully received from the talking PoC client;
b) bringing the PoC session to an IDLE state by the PoC server in a 1-to-1 session when either a T1 (End of RTP media—Talker) timer expires due to lack of media stream from the talking PoC client or when the T33 (End RTP media—Listener) timer expires due to lack of a TBCP_ACK message from the at least one listening PoC client based on the repetitive TBCP_TAKEN messages,
setting a plurality associated timers in each of the plurality of PoC clients, wherein the plurality of associated timers is selected from the group consisting of: a T13 (End of RTP media) timer in the talking PoC client, and a T11 (Cumulative TBCP_REQUEST) timer in the at least one listening PoC client, wherein the T11 (Cumulative TBCP_REQUEST) timer is set to a value equivalent to the T1 (End of RTP media—Talker) timer and the T13 (End of RTP media) timer; and
c) declaring the at least one listening PoC client as not reachable by the PoC server when either a T4 (Inactivity) timer expires due to lack of the media stream or the T34 (Inactivity—Listener) timer expires due to lack of the TBCP_ACK message from the at least one listening PoC client based on the repetitive TBCP_TAKEN message,
setting the T31 (Inactivity—Listener) to a value equivalent to the T4 (Inactivity) timer and the T34 (Inactivity—Listener) timer, and
removing the at least one listening PoC client from the PoC session.

21. The method of claim 13 wherein the media stream is selected from the group consisting of: audio, pictures, video, and text.

22. The method of claim 13 wherein the PoC session is selected from the group consisting of: a 1-to-1 PoC session, and a 1-to-many PoC session.

23. A method for providing a heartbeat in an Open Mobile Alliance (OMA) compliant Push-to-Talk over Cellular (PoC) system between a PoC server and at least two PoC clients during a single talk burst in an ongoing PoC session wherein the at least two PoC clients includes a talking PoC client and at least one listening PoC client, the method comprising:
applying a repetitive TBCP_REQUEST message by the talking PoC client to the PoC server;
acknowledging the repetitive TBCP_REQUEST message with a repetitive TBCP_GRANTED message by the PoC server to the talking PoC client;
applying a repetitive TBCP_TAKEN message by the PoC server to the at least one listening PoC client;
acknowledging the repetitive TBCP_TAKEN message with a repetitive TBCP_ACK message by the at least one listening PoC client to the PoC server;
if either the acknowledging fails, triggering at least one of three levels of actions upon expiry of one of a plurality of timers associated with the repetitive messages in order to inform the at least two PoC clients of an out of coverage condition wherein the actions include,
a) buffering the media stream on the PoC server on behalf of the at least one listening PoC client when a T32 (Start buffering) timer expires, and
releasing the media stream when a next acknowledging is successfully received from the talking PoC client;
b) bringing the PoC session to an IDLE state by the PoC server in a 1-to-1 session when either a T1 (End of RTP media—Talker) timer expires due to lack of media stream from the talking PoC client or when a T33 (End RTP media—Listener) timer expires due to lack of the plurality of TBCP_ACK messages from the at least one listening PoC client based on the repetitive TBCP_TAKEN messages,
setting the plurality associated timers in each of the plurality of PoC clients, wherein the plurality of associated timers is selected from the group consisting of: a T13 (End of RTP media) timer in the talking PoC client, and a T11 (Cumulative TBCP_REQUEST) timer in the at least one listening PoC client, wherein the T11 (Cumulative TBCP_REQUEST) timer is set to a value equivalent to the T1 (End of RTP media—Talker) timer and the T13 (End of RTP media) timer; and
c) declaring the at least one listening PoC client as not reachable by the PoC server when either a T4 (Inactivity) timer expires due to lack of the media stream or a T34 (Inactivity—Listener) timer expires due to lack of the plurality of TBCP_ACK messages from the at least one listening PoC client based on the repetitive TBCP_TAKEN messages,
setting a T31 (Inactivity—Listener) to a value equivalent to the T4 (Inactivity) timer and the T34 (Inactivity—Listener) timer, and
removing the at least one listening PoC client from the PoC session.
